(19) United States
(12) Patent Application Publication
(10) Pub. No.: US 2024/0283015 A1
(43) Pub. Date: Aug. 22, 2024

(54) BATTERY CELL INCLUDING A CONDUCTIVE LAYER AND METHOD OF MAKING THE SAME

(71) Applicant: GM GLOBAL TECHNOLOGY OPERATIONS LLC, Detroit, MI (US)

(72) Inventors: Seung-Woo Chu, Clawson, MI (US); Mansu Park, Rochester Hills, MI (US); Hwanchul Kim, Dryden, MI (US)

(73) Assignee: GM GLOBAL TECHNOLOGY OPERATIONS LLC, Detroit, MI (US)

(21) Appl. No.: 18/166,823

(22) Filed: Feb. 9, 2023

(51) Int. Cl. H01M 10/0565; H01M 10/058; H01M 50/59

(52) U.S. Cl. CPC H01M 10/0565; H01M 10/058; H01M 50/59; H01M 2300/0085

(57) ABSTRACT

An electrochemical battery cell may include an electrode assembly, a liquid electrolyte, a metallic battery enclosure or “can,” and a liquid solution. The electrode assembly and the electrolyte solution may be disposed within the battery can. The liquid solution may be disposed between the electrode assembly and the battery can. The liquid solution may include an organic solvent, a cross-linkable polymer and a cross-linking agent which may be converted into a conductive layer by reacting the cross-linkable polymer and the cross-linking agent of the liquid solution to form a reaction product. The liquid solution may include an ion conducting salt. The reaction product may be a polymer matrix and the organic solvent and/or the ion conducting salt may be contained within the polymer matrix. Reacting the cross-linkable polymer and the cross-linking agent may include applying heat to the liquid solution to convert the liquid solution into the reaction product.

The concepts described herein relate generally to electrochemical battery cells including, but not limited to, prismatic battery cells and cylindrical battery cells having metallic enclosures or “cans” and that include heat dissipation pathways for effective and consistent heat dissipation over a life of the battery cell.

A lithium-ion battery is an electrochemical device that operates by passing lithium ions between a negative electrode (or anode) and a positive electrode (or cathode). Generally, in most prismatic battery cells, the negative and positive electrodes are situated on opposite sides of a porous polymer separator to form an electrode stack. The electrode stack may include a protective wrap, and is disposed within a hollow, rectangular, metallic battery enclosure or “can,” and soaked or “wetted” with an electrolyte solution suitable for conducting lithium ions.

In most cylindrical battery cells, a jelly roll (JR) design is used. Generally, in the JR design, an insulating base is laid down, followed by the anode layer, the separator layer, and the cathode layer to form an electrode stack. The electrode stack is then rolled up into a cylinder and inserted into a hollow, metallic, cylindrical casing or battery can, and soaked or “wetted” with an electrolyte solution suitable for conducting lithium ions.

DC power sources, such as lithium-ion batteries, may be employed to store and release electric power that may be employed by an electric circuit or an electric machine to perform work, such as for communications, display, or propulsion. Heat may be generated by the processes of converting electric power to chemical potential energy, i.e., battery charging, and converting chemical potential energy to electric power, i.e., battery discharging.

Manufacturing a lithium-ion battery generally includes four stages: electrode production, electrode stack/jelly roll (JR) construction, cell assembly and end-of-line conditioning.

Electrode Production generally includes but may not be limited to: slurry mixing, coating, drying, calendaring and slitting/cutting.

Electrode Stack/JR Construction generally includes but may not be limited to winding/stacking.

Cell Assembly generally includes but may not be limited to: jointing tabs and/or terminals, electrode stack insertion, electrolyte filling and sealing.

End-of-line Conditioning generally includes but may not be limited to: formation, aging and electrical testing.

During manufacturing of the lithium-ion battery cell, more specifically, during the electrode stack insertion step of the cell assembly stage, a metallic battery can may be stiff enough to create a void space between the metallic battery can and the electrode stack.

During the electrolyte filling step of the cell assembly stage, the metallic battery can may not be filled completely with the electrolyte solution due to a slow wetting process.

Additionally, during the cell aging process, a portion of the electrolyte solution may be consumed through side reactions at the interfaces between the electrodes, i.e. the anodes and the cathodes, and the electrolyte solution.

Accordingly, electrolyte solution from a portion, for example but not limited to, a bottom portion, of the metallic battery can and the electrode stack may move into the electrode stack via capillary action to replace that which was consumed. As a result, the void space between the metallic battery can and the electrode stack may become larger and fill with gas, which may reduce the thermal conductivity within the battery cell significantly.

### SUMMARY

An electrochemical battery cell generally includes: an electrode assembly, a liquid electrolyte, a metallic battery enclosure or “can” containing the electrode assembly and the liquid electrolyte.

Electrochemical battery cells, including, but not limited to, prismatic battery cells and cylindrical battery cells, may include a void space, between a metallic battery can and an electrode stack contained within the metallic battery can, created during a manufacturing process.

The electrochemical battery cell also may not be filled completely with an electrolyte solution due to, for example, but not limited to, slow “wetting” of the electrode stack during the manufacturing process and/or a portion of the electrolyte solution being consumed through side reactions at interfaces between the electrodes and the electrolyte solution during an aging process, which may result in the void space becoming larger and filling with gas.

In one non-limiting embodiment of the present disclosure, an electrochemical battery cell may include an electrode assembly, a liquid electrolyte, a metallic battery can, and a liquid solution. The electrode assembly and the electrolyte solution may be disposed within the battery can. The liquid solution may be disposed between the electrode assembly and the battery can.

The liquid solution may include an organic solvent, a cross-linkable polymer and a cross-linking agent. The liquid solution may be converted into a conductive layer by reacting the cross-linkable polymer and the cross-linking agent of the liquid solution to form a reaction product.

The reaction product may be a three-dimensional polymer matrix and the organic solvent may be contained or captured within the three-dimensional polymer matrix. Reacting the cross-linkable polymer and the cross-linking agent may include applying heat to the liquid solution to convert the liquid solution into the reaction product.

As the organic solvent is contained within the three-dimensional polymer matrix, and the organic solvent is hydrogen bonded to the three-dimensional polymer matrix, the organic solvent captured within the conductive layer is not easily consumed during a cell aging process.

In one non-limiting embodiment of the present disclosure, the liquid solution includes an ion conducting salt, for example but not limited to, an ion conducting salt having a minimum ionic conductivity of 1.0×10⁻⁵ S cm⁻¹ at 25° C.

The conductive layer may be disposed between the electrode assembly and the battery can. The conductive layer may include the organic solvent contained within the reaction product.

As the conductive layer is not easily consumed as the battery cell is aged, the conductive layer may provide a heat dissipation pathway, between the electrode assembly and the battery can, which is more effective and consistent over the life of the battery cell, for example, but not limited to battery cells used in a rechargeable energy storage system (RESS).

In one non-limiting example, a conductive layer may include an ion conducting salt contained within a reaction product.

In one non-limiting example, a conductive layer may include an outer shape that substantially conforms to an inner shape of a battery can.

The electrode assembly may include an electrode stack. The electrode stack may include at least one separator layer, at least one anode, and at least one cathode. The at least one separator layer may be disposed between the at least one anode and the at least one cathode.

The at least one anode may include a first length and the at least one cathode may include a second length that is different from the first length of the at least one anode. The at least one anode may be stacked on a first side of the at least one separator layer and the cathode may be stacked on a second side, opposite the first side of the separator layer.

In one non-limiting example, a first length of the at least one anode is longer than a second length of the at least one cathode, such that the conductive layer may be in contact with at least one end portion of the at least one anode and spaced a distance apart from at least one end portion of the at least one cathode.

In one non-limiting embodiment of the present disclosure, the electrode stack may include a protective film wrap and the protective film wrap may include perforations that may facilitate infusion of the liquid solution into the protective film wrap.

In another non-limiting embodiment of the present disclosure, a method for making an electrochemical battery cell can include: pre-blending a liquid solution; pre-warming a bottom portion of a battery can; disposing the liquid solution within the battery can, wherein the liquid solution includes an organic solvent, a cross-linkable polymer and a cross-linking agent; transferring the battery can including the pre-blended liquid solution via a heated conveyor system; storing the battery can including the liquid solution and the electrode assembly, above room temperature; disposing an electrode assembly within the battery can; converting the liquid solution into a conductive layer disposed between the electrode assembly and the battery can; and disposing a liquid electrolyte within the battery can.

Converting the liquid solution into the conductive layer may include reacting the cross-linkable polymer and the cross-linking agent of the liquid solution to form a reaction product, such that the organic solvent is contained within the reaction product.

Reacting the cross-linkable polymer and the cross-linking agent of the liquid solution may include applying heat to the liquid solution.

The electrode assembly may include an electrode stack, which may include at least one separator layer, at least one anode, stacked on a first side of the at least one separator layer, and at least one cathode, stacked on second side of the at least one separator layer, wherein the second side of the at least one separator layer is opposite the first side of the at least one separator layer.

The liquid solution may be in contact with the at least one anode and spaced apart from the at least one cathode.

In one non-limiting example of the present disclosure, the electrode assembly may include a protective film wrap having perforations to facilitate infusion of the liquid solution. As such, when the liquid solution is converted into the conductive layer, the conductive layer, in turn, may extend into the protective film wrap via the protective film wrap perforations.

In one non-limiting example of the present disclosure, the liquid solution may include an ion conducting salt, for example but not limited to, an ion conducting salt having a minimum ionic conductivity of 1.0×10⁻⁵ S cm⁻¹ at 25° C.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1A is a schematic illustration of an example battery cell after electrolyte filling.

FIG. 1B is a schematic illustration of an example battery cell after sealing.

FIG. 1C is a schematic illustration of an example battery cell after aging.

FIG. 2 is a schematic illustration of an example battery cell constructed in accordance with the present disclosure, prior to electrolyte filling.

FIG. 3 is a schematic illustration of an example battery cell constructed in accordance with the present disclosure, after electrolyte filling.

FIG. 4 is a schematic illustration of an example battery cell constructed in accordance with the present disclosure, after sealing.

FIG. 4A is a cross-section of an example prismatic battery cell in accordance with the present disclosure.

FIG. 5 is a schematic illustration of an example battery cell constructed in accordance with the present disclosure, after aging.

FIG. 6 is a cross-section of an example cylindrical battery cell in accordance with the present disclosure.

FIG. 7 is a flow chart describing a method for making a battery cell in accordance with the present disclosure.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

Referring now to the drawings, wherein like numerals indicate like parts in several views, a battery cell, including a liquid solution converted to a conductive layer, and methods for making a battery cell, including a liquid solution converted to a conductive layer, are shown and described herein.

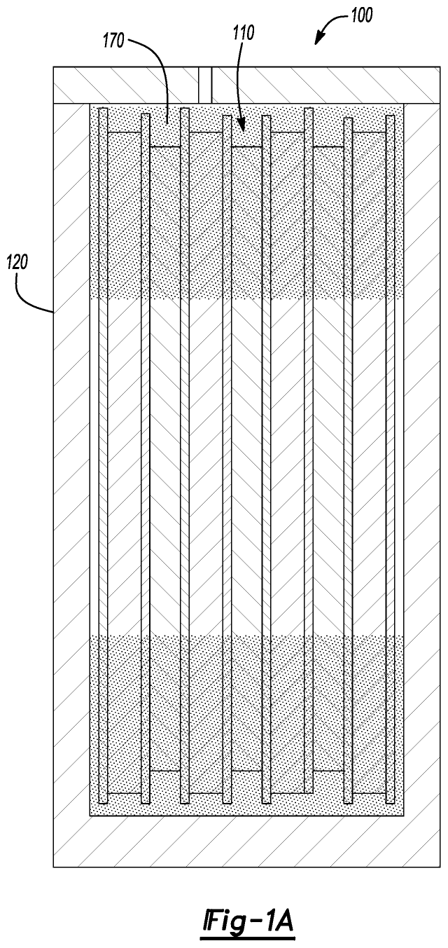

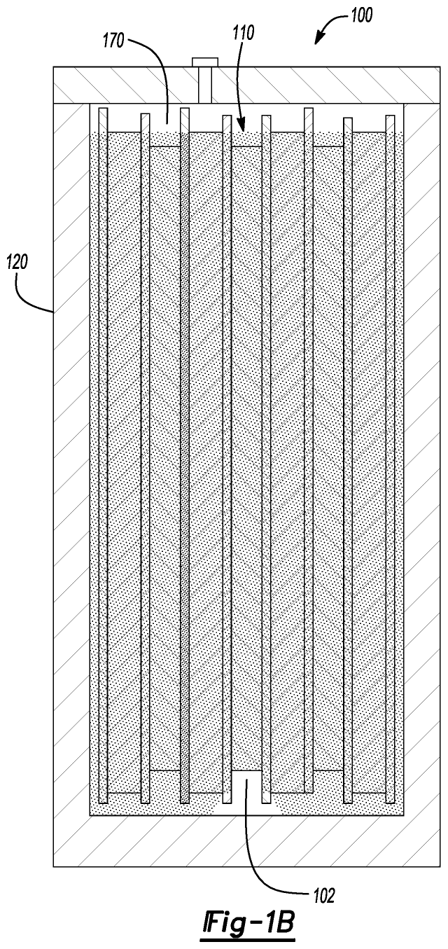

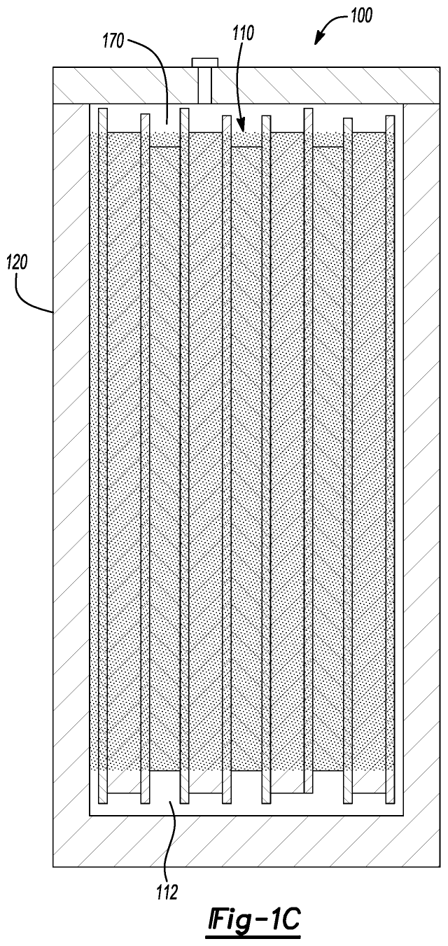

As generally illustrated in FIG. 1A, a battery cell 100 generally includes: an electrode assembly 110, a liquid electrolyte 170, and a metallic battery enclosure or “can” 120 containing the electrode assembly 110 and the liquid electrolyte 170.

As illustrated in FIG. 1B, the battery cell 100 may include a partial void space 102, between the battery can 120 and an electrode assembly 110, contained within the battery can 120, which can be created during a manufacturing process, for example, a cell assembly process.

The battery cell 100 may not be filled completely with the liquid electrolyte 170 due to, for example, but not limited to, slow “wetting” of the electrode assembly 110 during the manufacturing process.

As illustrated in FIG. 1C, a portion of the liquid electrolyte 170 may also be consumed through side reactions at interfaces within the electrode assembly 110 and the liquid electrolyte 170 as the battery cell 100 is aged, which may increase the partial void space 102, creating an air gap 112 between the electrode assembly 110 and the battery can 120.

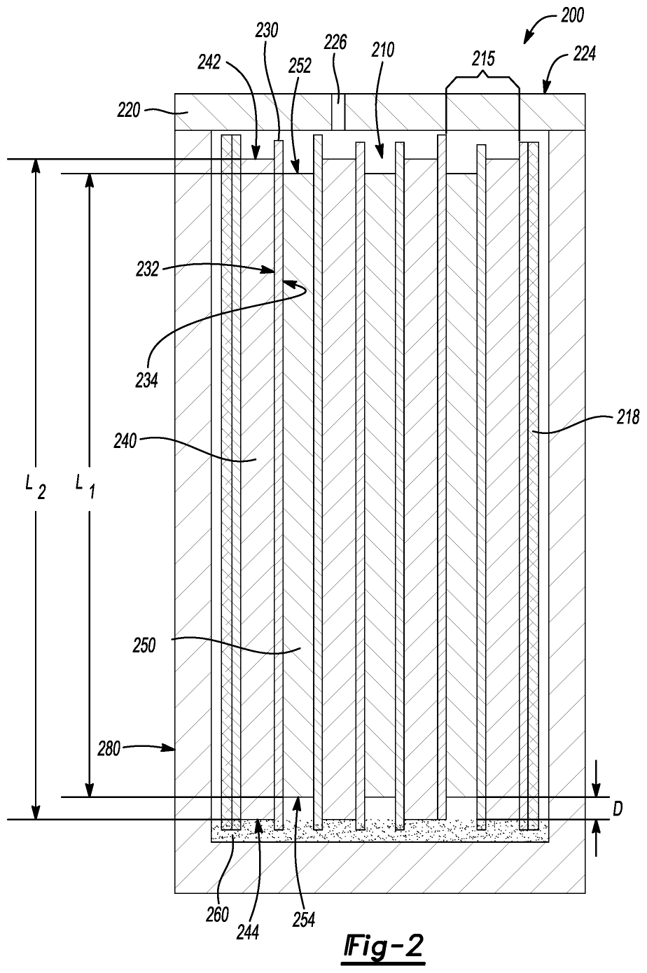

As generally illustrated in FIG. 2, a battery cell 200 is configured as a lithium-ion battery, in accordance the present disclosure, during manufacturing of the battery cell 200, prior to liquid electrolyte filling.

The battery cell 200 generally includes an electrode assembly 210 disposed within a metallic battery enclosure or battery can 220. The electrode assembly 210 includes an electrode stack 215 including at least one separator layer 230 (e.g., a microporous or nanoporous polymeric separator layer), at least one negative electrode or anode 240 and at least one positive electrode or cathode 250. The at least one separator layer 230 is disposed between the at least one anode 240 and the at least one cathode 250, such that the at least one anode 240 is stacked on a first side 232 of the at least one separator layer 230 and the at least one cathode 250 is stacked on a second side 234, opposite the first side 232, of the at least one separator layer 230.

A top assembly 224, including a filling hole 226, is disposed on the battery can 220.

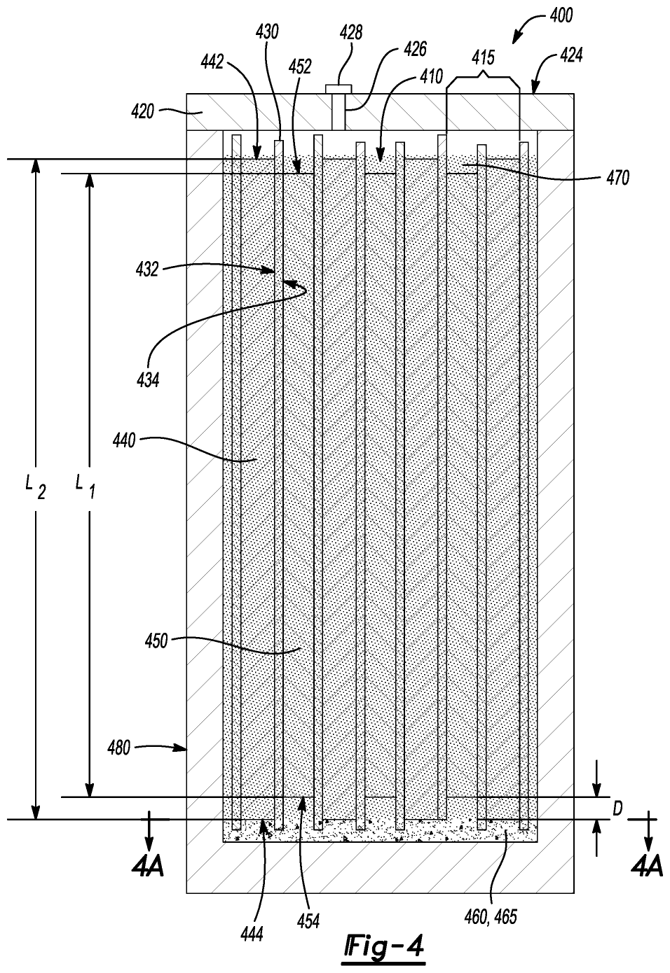

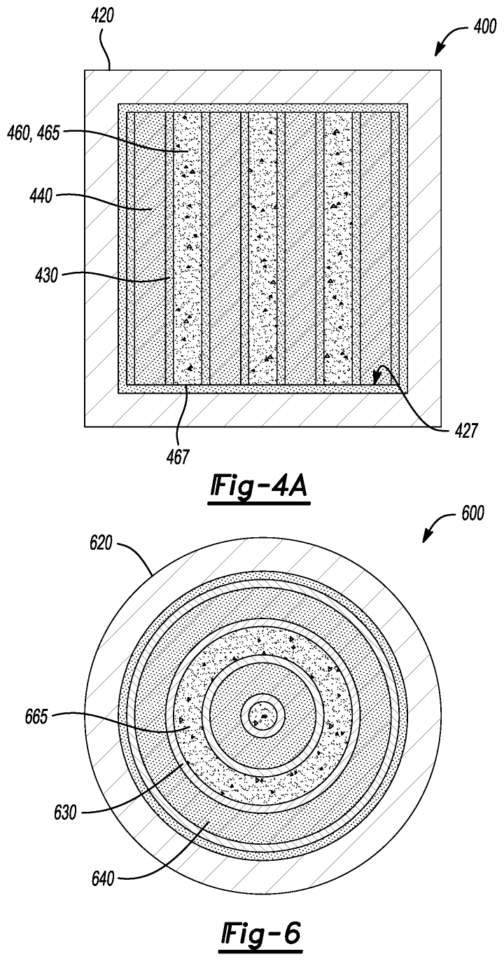

A liquid solution 260 is disposed between the electrode assembly 210 and the battery can 220, near a bottom portion 280 of the battery can 220. The liquid solution 260 includes: an organic solvent, a cross-linkable polymer and a cross-linking agent, in a free-flowing liquid form, which is converted into a conductive layer 465, shown in FIG. 4.

Non-limiting examples of the organic solvent may include, but are not limited to, a 3:7 volume mixture of ethylene carbonate (EC) (CAS. No. 96-49-1) and ethyl methyl carbonate (EMC) (Cas. No. 623-53-0); a mixture of at least two of the following: EC, EMC, diethyl carbonate (DEC) (Cas. No. 105-58-8), dimethyl carbonate (DMC) (Cas. No. 616-38-6), Fluoroethylene carbonate (FEC) (Cas. No. 11443-02-8); or other non-carbonate type solvent can be selected and blended, e.g. an ether based solvent.

A non-limiting example of the cross-linkable polymer may include, but is not limited to, a polyether copolymer having a weight-average molecular weight of 105 to 107 and including: (A) 3 to 30% by mol of repeating unit derived from propylene oxide; (B) 96 to 69% and by mol of repeating unit derived from ethylene oxide; and (C) 0.01 to 15% by mol of repeating unit derived from a monomer having one epoxy group and at least one reactive functional group represented by formula (I) or formula (2):

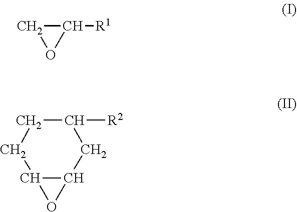

Non-limiting examples of the cross-linking agent or initiator may include, but are not limited to, Bis(4-tert-butylcyclohexyl) peroxydicarbonate (Cas. No. 15520-11-3) and t-Hexyl peroxy-3-ethyl hexanoate (Cas. No. 137791-98-1).

In one non-limiting embodiment, the electrode stack 215 may include a protective film wrap 218, which may be wrapped around the electrode stack 215. The protective film wrap 218 may include perforations (not shown) to facilitate infusion of the liquid solution 260 into the protective film wrap 218. As such, when the liquid solution 260, 460 is converted into the conductive layer 465, shown in FIG. 4, the conductive layer 465 may extend into the protective film wrap 218 via the protective film wrap perforations.

Referring back to FIG. 2, the at least one anode 240 includes a first top portion 242, a first bottom portion 244, and a first length L1. The at least one cathode 250 includes a second top portion 252, a second bottom portion 254, and a second length L2. The first length L1 of the at least one anode 240 is longer than the second length L2 of the at least one cathode 250, such that the first bottom portion 244 of the at least one anode 240 is in contact with the liquid solution 260 and the second bottom portion 254 of the at least one cathode 250 is spaced a distance D apart from the liquid solution 260.

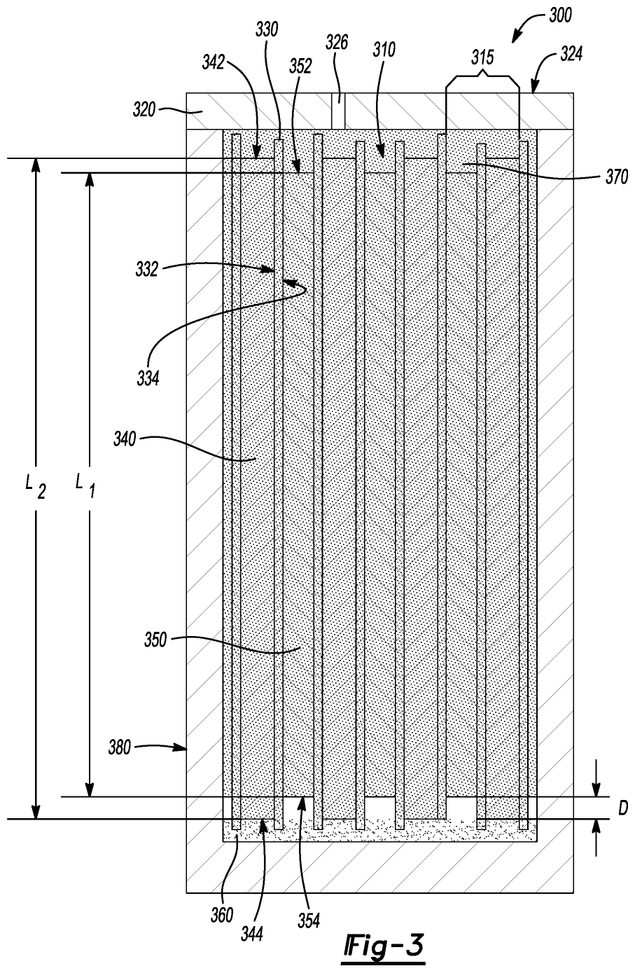

As generally illustrated in FIG. 3, a battery cell 300 is configured as a lithium-ion battery, in accordance the present disclosure, during manufacturing of the battery cell 300, after electrolyte filling.

The battery cell 300 includes an electrode assembly 310 disposed within a metallic battery enclosure or battery can 320. The electrode assembly 310 includes an electrode stack 315 including at least one separator layer 330 (e.g., a microporous or nanoporous polymeric separator layer), at least one negative electrode or anode 340, at least one positive electrode or cathode 350. The at least one separator layer 330 is disposed between the at least one anode 340 and the at least one cathode 350, such that the at least one anode 340 is stacked on a first side 332 of the at least one separator layer 330 and the at least one cathode 350 is stacked on a second side 334, opposite the first side 332 of the at least one separator layer 330.

A top assembly 324, including a filling hole 326, is disposed on the battery can 320.

A liquid solution 360 is disposed between the electrode assembly 310 and the battery can 320, near a bottom portion 380 of the battery can 320.

In one embodiment, the liquid solution 360 includes: an organic solvent, a cross-linkable polymer and a cross-linking agent, which may be converted into conductive layer 465, shown in FIG. 4.

In another embodiment, the liquid solution 360 may include: an organic solution, a cross-linkable polymer, a cross-linking agent and an ion conducting salt, wherein the ion conducting salt may have, but is not limited to, a minimum ion conductivity of 1.0×10⁻⁵ S cm⁻¹ at 25° C. The ion conducting salt may provide, for example but not limited to, an increase in manufacturing speed and/or tighter tolerances.

The at least one anode 340 includes a first top portion 342, a first bottom portion 344, and a first length L1 and the at least one cathode 350 includes a second top portion 352, a second bottom portion 354, and a second length L2. The first length L1 of the at least one anode 340 is longer than the second length L2 of the at least one cathode 350, such that the first bottom portion 344 of the at least one anode 340, including the at least one separator layer 330, is in contact with the liquid solution 360 and the second bottom portion 354 of the at least one cathode 350 is spaced a distance D apart from the liquid solution 360.

A liquid electrolyte 370 is disposed within the battery can 320, however, the electrode stack 315 has not been completely “wetted” by the liquid electrolyte 370.

As generally illustrated in FIG. 4, a battery cell 400 is configured as a lithium-ion battery, in accordance with the present disclosure, during manufacturing, after sealing of a filling hole 426 included in a top assembly 424 with a filling hole insert 428 and conversion of a liquid solution 460 to a conductive layer 465.

The battery cell 400 includes an electrode assembly 410 disposed within a metallic battery enclosure or battery can 420. The electrode assembly 410 includes an electrode stack 415 including at least one separator layer 430 (e.g., a microporous or nanoporous polymeric separator layer), at least one negative electrode or anode 440, at least one positive electrode or cathode 450. The at least one separator layer 430 is disposed between the at least one anode 440 and the at least one cathode 450, such that the at least one anode 440 is stacked on a first side 432 of the at least one separator layer 430 and the at least one cathode 450 is stacked on a second side 434, opposite the first side 432 of the at least one separator layer 430.

The top assembly 424, including the filling hole 426, is disposed on the battery can 420. The filling hole insert 428 may be temporarily disposed within the filling hole 426. The liquid solution 460, which is disposed between the electrode assembly 410 and

the battery can 420, near a bottom portion 480 of the battery can 420, includes an organic solvent, a cross-linkable polymer and a cross-linking agent, in a free flowing liquid form.

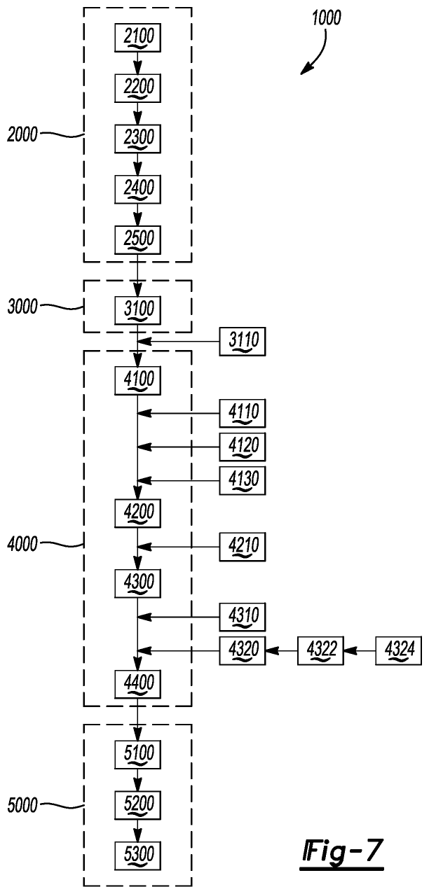

As illustrated in FIG. 7, a method of converting the liquid solution 460 into the conductive layer 465 includes reacting the cross-linkable polymer and the cross-linking agent of the liquid solution 460 to form a reaction product that is non-free flowing, for example, but not limited to, a three-dimensional polymer matrix. As the organic solvent is contained or captured within the reaction product or three-dimensional polymer matrix and hydrogen bonded with the three-dimensional polymer matric, the organic solvent inside the three-dimensional polymer matrix is not easily consumed as the cell ages.

Referring now to FIG. 4A, a cross-section of the battery cell 400 is shown. The cross-section of battery cell 400 includes the electrode assembly 410 disposed within the battery can 420. The electrode assembly 410 includes the at least one separator layer 430, the at least one anode 440, and the at least one cathode (not shown). The conductive layer 465 is disposed within the battery can 420, between the electrode assembly 410 and the battery can 420. The conductive layer 465 includes an outer shape 467 that substantially conforms to an inner shape 427 of the battery can 420.

In the illustrated embodiment, the battery cell 400 is a prismatic battery cell, however, it should be appreciated that the battery cell 400 may also be, but is not limited to, a cylindrical battery cell, a cross-section of which is shown in FIG. 6, wherein like numerals represent like parts.

As cross-section illustrated in FIG. 6, a battery cell 600 is a cylindrical battery cell. The cross-section of battery cell 600 includes the electrode assembly 610 disposed within the battery can 620. The electrode assembly 610 includes the at least one separator layer 630, the at least one anode 640, and the at least one cathode (not shown). The conductive layer 665 is disposed within the battery can 620, between the electrode assembly 610 and the battery can 620. The conductive layer 665 includes an outer shape 667 that substantially conforms to an inner shape 627 of the battery can 620.

Referring back to FIG. 4, the at least one anode 440 includes a first top portion 442, a first bottom portion 444, and a first length L1. The at least one cathode 450 includes a second top portion 452, a second bottom portion 454, and a second length L2. The first length L1 of the at least one anode 440 is longer than the second length L2 of the at least one cathode 450, such that the first bottom portion 444 of the at least one anode 440, including the at least one separator layer 430, is in contact with the liquid solution 460 and the second bottom portion 454 of the at least one cathode 450 is spaced a distance D apart from the liquid solution 460.

A liquid electrolyte 470 is disposed within the battery can 420 and the electrode stack 415 is substantially “wetted” by the liquid electrolyte 470, such that the liquid electrolyte 470 is disposed between the at least one anode 440 and the at least one cathode 450 and interfaces with the at least one separator layer 430, for example, the liquid electrolyte 470 is disposed in pores of the at least one separator layer 430. The liquid electrolyte 470 may also be present in the at least one anode 440 and the at least one cathode 450, such as in their respective pores.

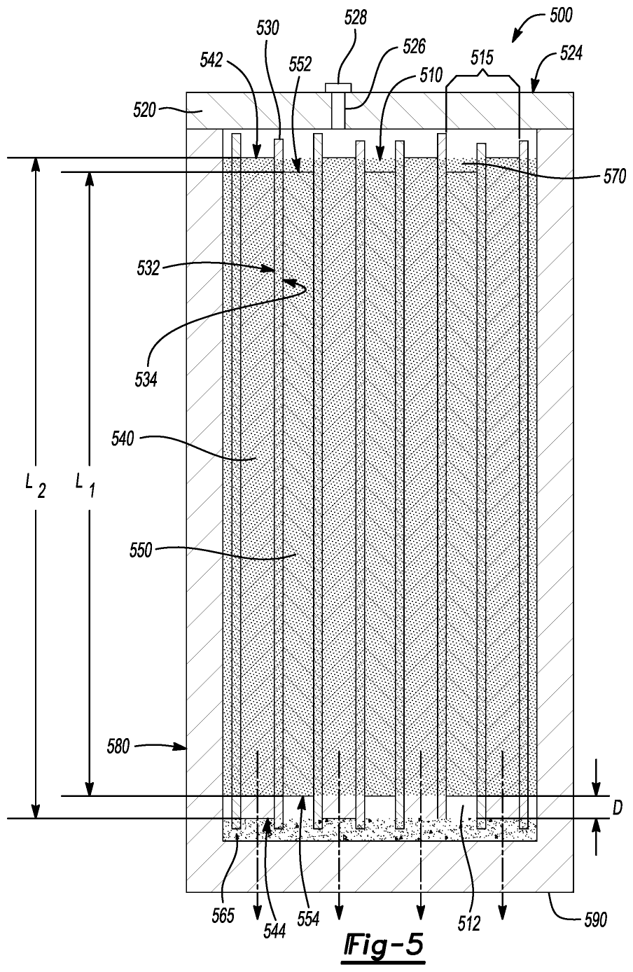

As generally illustrated in FIG. 5, a battery cell 500 is configured as a lithium-ion battery, in accordance with the present disclosure, after manufacturing of the battery cell 500 and the battery cell 500 has been aged.

The battery cell 500 includes an electrode assembly 510 disposed within a metallic battery enclosure or battery can 520. The electrode assembly 510 includes an electrode stack including at least one separator layer 530 (e.g., a microporous or nanoporous polymeric separator layer), at least one negative electrode or anode 540, at least one positive electrode or cathode 550. The at least one separator layer 530 is disposed between the at least one anode 540 and the at least one cathode 550, such that the at least one anode 540 is stacked on a first side 532 of the at least one separator layer 530 and the at least one cathode 550 is stacked on a second side 534 of the at least one separator layer 530, wherein the second side 534 of the at least one separator layer 530 is opposite the first side 532 of the at least one separator layer 530.

The top assembly 524, including the filling hole 526, is disposed on the battery can 520. A filling hole insert 528 may be permanently disposed within the filling hole 526 or the filling hole 526 may be otherwise sealed, for example, by laser welding.

A conductive layer 565, which is disposed between the electrode assembly 510 and the battery can 520, includes an organic solvent contained within a polymer matrix.

The at least one anode 540 includes a first top portion 542, a first bottom portion 544, and a first length L1 and the at least one cathode 550 includes a second top portion 552, a second bottom portion 554, and a second length L2. The first length L1 of the at least one anode 540 is longer than the second length L2 of the at least one cathode 550, such that the first bottom portion 544 of the at least one anode 540, including the at least one separator layer 530, is in contact with the conductive layer 565 and the second bottom portion 554 of the at least one cathode 550 is spaced a distance D apart from the conductive layer 565.

As the conductive layer 565 is in direct contact with the at least one anode 540, including the at least one separator layer 530, folding of the separator layer 530, in the event of high acceleration or deceleration of the battery cell 500 during use, may be reduced or prevented.

A liquid electrolyte 570 is disposed within the battery can 520. As the battery cell 500 is aged, a portion of the liquid electrolyte 570, generally located at a bottom portion 580 of the battery can 520, is consumed through side reactions at interfaces within the electrode assembly 510 and the liquid electrolyte 570, creating an air gap 512 between the electrode assembly 510 and the battery can 520, which may reduce thermal conductivity between the electrode assembly 510 and the battery can 520.

As the conductive layer 565, disposed between the electrode assembly 510 and the battery can 520, is not easily consumed as the battery cell 500 ages, the conductive layer 565 provides a heat dissipation pathway 590, between the electrode assembly 510 and the battery can 520, which is more effective and consistent over the life of the battery cell 500, for example, but not limited to battery cells 500 used in a rechargeable energy storage system (RESS).

In one embodiment, the heat dissipation pathway 590 travels downward from the electrode assembly 510, through the conductive layer 565, to the battery can 520, however, it should be appreciated that the heat dissipation pathway 590 could travel in a lateral direction from the electrode assembly 510 through the conductive layer 565, to the battery can 520, and/or upwards from the electrode assembly 510, through the conductive layer 565, to the battery can 520, as required based on a configuration and/or orientation of the electrode assembly 510 and the conductive layer 565 within the battery can 520.

In one embodiment, the electrode assembly 510 includes an electrode stack 515, typically used in a prismatic battery cell, however, the electrode assembly 510 may also include a jelly roll (JR) design (not shown), typically used in cylindrical battery cells.

Generally, in the JR design, an insulating base is laid down, followed by the anode layer, the separator layer, and the cathode layer to form an electrode stack. The electrode stack is then rolled up into a cylinder and inserted into a hollow, metallic, cylindrical casing or battery can, and soaked or “wetted” with an electrolyte solution suitable for conducting lithium ions.

As illustrated in FIG. 7, a method of making a lithium-ion battery 1000 generally includes four stages: electrode production 2000, electrode stack/jelly roll (JR) construction 3000, cell assembly 4000 and end-of-line conditioning 5000.

Electrode Production 2000 generally includes but may not be limited to: slurry mixing 2100, coating 2200, drying 2300, calendaring 2400 and slitting/cutting 2500.

Electrode Stack/JR Construction 3000 generally includes but may not be limited to: winding/stacking 3100.

Cell Assembly 4000 generally includes but may not be limited to: jointing tabs and/or terminals 4100, electrode stack insertion 4200, electrolyte filling 4300 and sealing 4400.

End-of-line Conditioning 5000 generally includes but may not be limited to: formation 5100, aging 5200 and electrical testing 5300.

In one non-limiting embodiment of the present disclosure, a method for making a battery cell 400 can include: pre-blending a liquid solution 3110, 4110, wherein pre-blending the liquid solution 4110 follows the electrode winding/stacking 3100 and may follow jointing tabs and/or terminals 4100 or occur prior to jointing tabs and/or terminals 4100; disposing the pre-blended liquid solution within the battery can 4120, wherein the pre-blended liquid solution includes an organic solvent, a cross-linkable polymer and a cross-linking agent and wherein the pre-blended liquid solution is disposed within the battery can 4120 prior to electrode stack insertion 4200; pre-warming a bottom portion of the battery can 4210, wherein pre-warming the bottom portion of the battery can 4210 follows the electrode stack insertion 4200; transferring the battery can including the pre-blended liquid solution via a heated conveyor system 4130 wherein the battery, including the pre-blended solution, is transferred via the heated conveyor system 4130 after the pre-blended solution is disposed within the battery can 4120 and during, at least, the cell assembly 4000; storing the battery can including the liquid solution and the electrode assembly above room temperature 4310, wherein the battery can including the liquid solution and the electrode assembly is stored above room temperature 4310 prior to disposing the liquid electrolyte within the battery can 4400; disposing an electrode assembly within the battery can 4300, wherein the electrode assembly is disposed within the battery can 4300 prior to disposing the liquid electrolyte within the battery can 4400; converting the liquid solution into a conductive layer 4320 disposed between the electrode assembly and the battery can, wherein the liquid solution is converted into the conductive layer 4320 prior to disposing the liquid electrolyte within the battery can 4400; and disposing the liquid electrolyte within the battery can 4400.

Converting the liquid solution into the conductive layer 4320 may include reacting the cross-linkable polymer and the cross-linking agent of the liquid solution to form a reaction product 4322, such that the organic solvent is contained within the reaction product, and wherein the reaction product may be a three-dimensional polymer matrix.

Reacting the cross-linkable polymer and the cross-linking agent of the liquid solution to form a reaction product 4322 may also include gelation of the liquid solution from a free flowing liquid to a non-free flowing gel, wherein the organic solvent is contained within the gel.

Reacting cross-linkable polymer and the cross-linking agent of the liquid solution to form the reaction product 4322 may include applying heat to the liquid solution 4324.

As converting the liquid solution into the conductive layer 4320 begins after the electrode stack is disposed within the battery can 4300, risk of mechanical damage to and/or dimensional change of the electrode stack may be minimized.

In one embodiment, as illustrated above in FIGS. 2-6, the electrode stack 215 may include at least one separator layer 230, at least one anode 240, stacked on one side of the at least one separator layer 230, and at least one cathode 250, stacked on an opposite side of the at least one separator layer 230. The electrode stack 215 may be included in an electrode assembly 210.

The liquid solution 260 may be in contact with the at least one anode 240 and spaced apart from the at least one cathode 250.

In one non-limiting example of the present disclosure, the electrode assembly 210 may include a protective film wrap 218 having perforations (not shown) to facilitate infusion of the liquid solution 260.

In another non-limiting example of the present disclosure, the liquid solution 260 may include an ion conducting salt, for example but not limited to, an ion conducting salt having a minimum ionic conductivity of 1.0×10⁻⁵ S cm⁻¹ at 25° C.

These and other attendant benefits of the present disclosure will be appreciated by those skilled in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A battery cell, comprising:
an electrode assembly;
a liquid electrolyte;
a battery can containing the electrode assembly and the liquid electrolyte; and
a liquid solution comprising:
an organic solvent;
a cross-linkable polymer; and
a cross-linking agent, wherein the liquid solution is converted to a conductive layer disposed between the electrode assembly and the battery can.

2. The battery cell as recited in claim 1, wherein the liquid solution is converted to the conductive layer by reacting the cross-linkable polymer and the cross-linking agent of the liquid solution to form a reaction product, wherein the organic solvent is contained within the reaction product.

3. The battery cell as recited in claim 2, wherein the reaction product is a polymer matrix and the organic solvent is contained within the polymer matrix.

4. The battery cell as recited in claim 1, wherein the electrode assembly includes an electrode stack comprising:
at least one separator layer;
at least one anode, having a first length, stacked on a first side of the at least one separator layer; and
at least one cathode, having a second length, stacked on a second side, opposite the first side, of the at least one separator layer, wherein one of the first length and the second length is longer than another of the first length and the second length.

5. The battery cell as recited in claim 4, wherein the conductive layer is in contact with an end portion of the at least one anode and spaced apart from an end portion of the at least one cathode.

6. The battery cell as recited in claim 4, wherein the electrode stack further includes a protective film wrap, wherein the protective film wrap includes perforations.

7. The battery cell as recited in claim 6, wherein the perforations facilitate infusion of the liquid solution into the protective film wrap.

8. The battery cell as recited in claim 1, the conductive layer having an outer shape that substantially conforms to an inner shape of the battery can.

9. The battery cell as recited in claim 1, wherein the liquid solution includes an ion conducting salt.

10. The battery cell as recited in claim 9, wherein the ion conducting salt has a minimum ionic conductivity of 1.0×10⁻⁵ S cm⁻¹ at 25° C.

11. A method for making a battery cell comprising:
disposing a liquid solution within a battery can, wherein the liquid solution includes an organic solvent, a cross-linkable polymer and a cross-linking agent;
disposing an electrode assembly within the battery can;
converting the liquid solution into a conductive layer disposed between the electrode assembly and the battery can; and
disposing a liquid electrolyte within the battery can.

12. The method of making a battery cell as recited in claim 11, further including pre-blending the liquid solution.

13. The method of making a battery cell as recited in claim 12, further including: pre-warming a bottom portion of the battery can, prior to disposing the liquid solution within the battery can.

14. The method of making a battery cell as recited in claim 13, further including: transferring the battery can including the pre-blended liquid solution via a heated conveyor system.

15. The method of making a battery cell as recited in claim 14, further including: storing the battery can, including the liquid solution and the electrode assembly, above room temperature, prior to disposing the liquid electrolyte within the battery can.

16. The method of making a battery cell as recited in claim 11, wherein converting the liquid solution into the conductive layer includes reacting the cross-linkable polymer and the cross-linking agent of the liquid solution to form a reaction product, wherein the organic solvent is contained within the reaction product.

17. The method of making a battery cell as recited in claim 16, wherein reacting the cross-linkable polymer and the cross-linking agent of the liquid solution includes applying heat to the liquid solution.

18. The method of making a battery cell as recited in claim 11, further including: assembling the electrode assembly, wherein the electrode assembly includes an electrode stack comprising:
at least one separator layer;
at least one anode, stacked on one side of the at least one separator layer; and
at least one cathode, stacked on an opposite side of the at least one separator layer, wherein the liquid solution is in contact with the at least one anode and spaced apart from the at least one cathode.

19. The method of making a battery cell as recited in claim 18, wherein the electrode stack includes a protective film wrap having perforations to facilitate infusion of the liquid solution.

20. The method of making a battery cell as recited in claim 11, wherein the liquid solution includes an ion conducting salt.
